(19) United States
(12) Patent Application Publication
(10) Pub. No.: US 2007/0040792 A1
(43) Pub. Date: Feb. 22, 2007

(54) Shift register for display device and display device including a shift register

(75) Inventors: Jin-Oh Kwag, Suwon-si (KR); Young-Joo Park, Hwaseong-si (KR); Jae-Myong Yoo, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/450,841

(22) Filed: Jun. 10, 2006

(30) Foreign Application Priority Data
Jun. 23, 2005 (KR) 10-2005-0054427

(51) Int. Cl. G09G 3/36

(52) U.S. Cl. 345/100

(57) ABSTRACT

A shift register that is capable of performing partial driving and a display device having the shift register, in which the shift register has at least two display regions, each of which includes pixels and signal lines connected thereto. The shift register includes at least two stage groups, each of which includes a plurality of stages connected to each other to sequentially generate output signals, wherein each stage group transmits the output signals to the signal lines included in one of the two display regions. Accordingly, the shift register is divided into a plurality of the stage groups, and only the necessary portion of a screen can be displayed, so that it is possible to reduce power consumption.

### CROSS-REFERENCE TO RELATED PATENT APPLICATION

This application claims priority to Korean Patent Application No. 2005-0054427, filed on Jun. 23, 2005, and all the benefits accruing therefrom under 35 U.S.C. §119, and the contents of which in its entirety are herein incorporated by reference.

### BACKGROUND OF THE INVENTION

(a) Technical Field

The present disclosure relates to a shift register for a display device and a display device including the shift register.

(b) Discussion of the Related Art

Recently, flat panel display devices such as organic light emitting diode (OLED) display devices, plasma display panel (PDP) devices, and liquid crystal display (LCD) devices have been actively developed as a substitute for large and heavy cathode ray tubes (CRT).

The PDP is a device for displaying characters or images by using plasma generated from gas discharge, and the OLED is a device for displaying characters or images by using electric field emission of specific organic materials or polymers. The LCD is a device for displaying images by applying an electric field to a liquid crystal layer between two panels and adjusting transmittance of light passing through the liquid crystal layer by controlling a strength of the electric field.

Among the display devices, a dual display device having two panel terminal units provided to outer and inner sides thereof has been actively developed. The dual display device is a medium- or small-sized display device, and is particularly suitable for a mobile phone.

The dual display device includes a main panel unit mounted on an inner side thereof, an subsidiary panel unit mounted on an outer side thereof, a driving flexible printed circuit film (FPC) provided with wires to transmit input signals from external devices, an auxiliary FPC for connecting the main panel unit with the subsidiary panel unit, and an integration chip for controlling these components.

Among the dual display devices, the LCD and the OLED include a panel on which pixels including switching elements and display signal lines are disposed, a gate driver for transmitting gate-on and gate-off voltages to gate lines of the display signal lines to turn the switching elements of the pixels on and off, and a data driver for transmitting data voltages to data lines of the display signal lines to apply the data voltages to the pixels through a turned-on switching element. An integration chip generates driving and control signals for controlling the gate and data drivers of the main and subsidiary panel units. The integration chip is generally mounted on the main panel unit in a form of a chip-on-glass (COG).

In some of the small- or medium-sized display devices, the gate driver is formed and integrated in the panel units in the same process used for forming the switching elements of the pixels in order to reduce production costs.

The gate driver includes a plurality of stages that are substantially connected to each other with shift registers and are aligned in a row. The first stage receives a scan start signal and transmits a gate output. At the same time, the first stage transmits a carry output to the next stage to sequentially generate gate outputs.

However, even in a partial operation mode for displaying only a partial image on a screen, the scan start signal is input to the first stage to operate all the stages, so that too much power is consumed.

### SUMMARY OF THE INVENTION

Embodiments of the present invention provide a shift register that is capable of reducing power consumption by implementing a partial operation mode, and a display device including the shift register.

According to an embodiment of the present invention, there is provided a shift register for a display device having at least two display regions, each of which includes pixels and signal lines connected thereto, the shift register comprising at least two stage groups, each of which includes a plurality of stages connected to each other to sequentially generate output signals, wherein each stage group transmits the output signals to the signal lines included in one of the two display regions.

In an embodiment of the present invention, at least one of the stage groups may be applied with a scan start signal. The scan start signal may be input to a first stage of each stage group, and it may be input in synchronization with an output of a last stage of an upper adjacent stage group.

Each stage may include set, reset, gate-off voltage, and output terminals, and first and second clock terminals. In addition, each stage may include: a first switching element having a first terminal connected to the first clock terminal, a second terminal connected to a first contact point, and a third terminal connected to the output terminal; a second switching element having first and second terminals commonly connected to the set terminal and a third terminal connected to the first contact point; a third switching element having a first terminal connected to the first contact point, a second terminal connected to the reset terminal, and a third terminal connected to the gate-off voltage terminal; a fourth switching element having a first terminal connected to the first contact point, a second terminal connected to a second contact point, and a third terminal connected to the gate-off voltage terminal; a fifth switching element having a first terminal connected, to the output terminal, a second terminal connected to the second contact point, and a third terminal connected to the gate-off voltage terminal; a sixth switching element having a first terminal connected to the output terminal, a second terminal connected to the second clock terminal, and a third terminal connected to the gate-off voltage terminal; a seventh switching element having a first terminal connected to the second contact point, a second terminal connected to the first contact point, and a third terminal connected to the gate-off voltage terminal; a first capacitor connected between the first clock terminal and the second contact point; and a second capacitor connected between the first contact point and the output terminal. Further, the first to seventh switching elements may be made of amorphous silicon.

According to another aspect of the present invention, there is provided a display device including at least two display regions, each of which includes a plurality of pixels including switching elements and a plurality of signal lines connected to the switching element, and a shift register including a plurality of stages connected to each other to sequentially generate output signals and apply the output signals to signal lines included in one of the two display regions.

In the embodiment of the present invention, at least one of the stage groups may be applied with a scan start signal. In addition, the scan start signal may be input to a first stage of each stage group, and it may be input in synchronization with an output of a last stage of an upper adjacent stage group.

Each stage may include set, reset, gate-off voltage, and output terminals, and first and second clock terminals. In addition, each stage may include: a first transistor having a first terminal connected to the first clock terminal, a second terminal connected to a first contact point, and a third terminal connected to the output terminal; a second transistor having first and second terminals commonly connected to the set terminal and a third terminal connected to the first contact point; a third transistor having a first terminal connected to the first contact point, a second terminal connected to the reset terminal, and a third terminal connected to the gate-off voltage terminal;a fourth transistor having a first terminal connected to the first contact point, a second terminal connected to a second contact point, and a third terminal connected to the gate-off voltage terminal; a fifth transistor having a first terminal connected to the output terminal, a second terminal connected to the second contact point, and a third terminal connected to the gate-off voltage terminal; a sixth transistor having a first terminal connected to the output terminal, a second terminal connected to the second clock terminal, and a third terminal connected to the gate-off voltage terminal; a seventh transistor having a first terminal connected to the second contact point, a second terminal connected to the first contact point, and a third terminal connected to the gate-off voltage terminal; a first capacitor connected between the first clock terminal and the second contact point; and a second capacitor connected between the first contact point and the output terminal. Further, the first to seventh transistors may be made of amorphous silicon.

The display device may further include a circuit unit for outputting a plurality of the scan start signals at different times. Some of the scan start signals may be input in synchronization with an output of a last stage of the stage groups.

The display device may further include a panel unit having the display region, wherein the shift register is integrated in the panel unit.

The display device may be a liquid crystal display device.

### BRIEF DESCRIPTION OF THE DRAWINGS

Exemplary embodiments of the present invention can be understood in more detail from the following descriptions taken in conjunction with the attached drawings, in which:

FIG. 1 is a schematic diagram showing a liquid crystal display device according to an embodiment of the present invention;

FIG. 2 is a block diagram showing a liquid crystal display device according to an embodiment of the present invention;

FIG. 3 is an equivalent circuit diagram showing a pixel of a liquid crystal display device according to an embodiment of the present invention;

FIG. 4 is a view showing an example of partial driving of a liquid crystal display device according to an embodiment of the present invention;

FIG. 5 is a block diagram showing a gate driver according to an embodiment of the present invention;

FIG. 6 is a circuit diagram showing an example of a j-th stage of a shift register for the gate driver shown in FIG. 5;

FIG. 7 are waveforms of signals of the gate driver shown in FIG. 5;

FIG. 8 is a circuit diagram showing an example of a scan start signal generator of a liquid crystal display device according to an embodiment of the present invention; and

FIG. 9 waveforms of signals of a shift register shown in FIG. 5.

### DESCRIPTION OF EXEMPLARY EMBODIMENTS

Exemplary embodiments of the present invention are described more fully hereinafter with reference to the attached drawings.

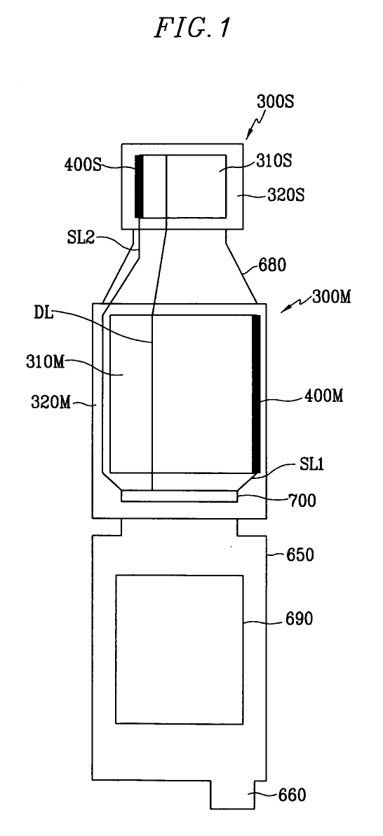

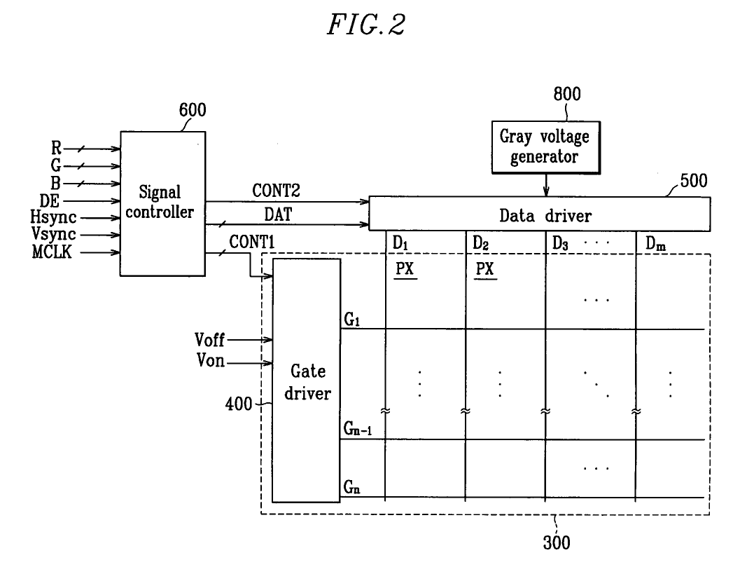

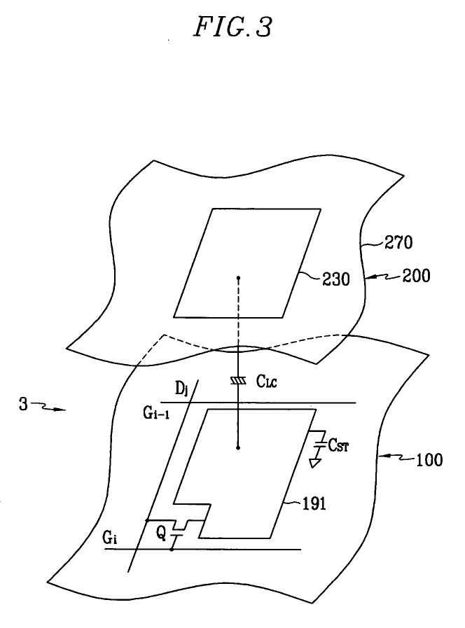

FIG. 1 is a schematic diagram showing a liquid crystal display device according to an embodiment of the present invention, FIG. 2 is a block diagram showing a liquid crystal display device according to an embodiment of the present invention, and FIG. 3 is an equivalent circuit diagram showing a pixel of a liquid crystal display device according to an embodiment of the present invention.

If not particularly denoted, a gate driver 400 may be a gate driver 400M or a gate driver 400S.

Referring to FIG. 1, a display device according to the embodiment of the present invention includes a main panel unit 300M, a subsidiary panel unit 300S, a flexible printed circuit film (FPC) 650 attached to the main panel unit 300M, an auxiliary FPC 680 attached between the main and subsidiary panel units 300M and 300S, and an integration chip 700 mounted on the main panel unit 300M.

The FPC 650 is attached in the vicinity of one edge of the main panel unit 300M. In addition, when the FPC 650 is folded in an assembly state thereof, there is provided an open portion 690 for exposing a portion of the main panel unit 300M. Under the open portion 690, there are provided an input portion 660 through which an external signal can be input and further provided are a plurality of signal lines (not shown) for electrical connection between the input portion 660 to the integration chip 700 and between the integration chip 700 and the main panel unit 300M. The signal lines have pads (not shown) formed by widening widths of the signal lines at positions where the signal lines are connected to the integration chip 700 and attached to the main panel unit 300M.

The auxiliary FPC 680 is attached between the side of the main panel unit 300M opposite to where the FPC 650 is mounted and one side of the subsidiary panel unit 300S, and includes signal lines SL2 and DL for electrical connection between the integration chip 700 and the subsidiary panel unit 300S.

The panel units 300M and 300S respectively include display regions 310M and 310S constituting screens, and peripheral regions 320M and 320S. The peripheral regions 320M and 320S may be provided with light blocking layers (not shown), sometime referred to as a black matrix, for blocking light. The FPC 650 and the auxiliary FPC 680 are attached to the peripheral regions 320M and 320S.

As shown in FIG. 2, each of the display regions 310M and 310S represented at 300 includes a plurality of display signal lines including a plurality of gate lines G₁ to Gₙ and a plurality of data lines D₁-Dₘ, a plurality of pixels PX that are arrayed substantially in a matrix, and a gate driver 400 for applying signals to the gate lines G₁ to Gₙ. Most of the pixels and the gate lines G₁ to Gₙ are disposed in the display regions 310M and 310S. The gate drivers 400M and 400S are disposed in the peripheral regions 320M and 320S, respectively.

The portions of the peripheral regions 320M and 320S where the gate drivers 400M and 400S are disposed have larger widths that other portions of the peripheral regions.

As shown in FIGS. 1 and 2, the data lines D₁-Dₘ of the main panel unit 300M are connected to the subsidiary panel unit 300S through the auxiliary FPC 680. More specifically, the panel units 300M and 300S share the data lines D₁-Dₘ, and one of the data lines is shown in FIG. 1 as denoted by DL.

Since the upper panel 300S is smaller than the lower panel 300M, a region of the lower panel 300M is exposed, and the data lines D₁-Dₘ extend to the region to be connected to a data driver 500. The gate lines G₁ to Gₙ extend to locations covered with the peripheral regions 320M and 320S to be connected to the gate drivers 400M and 400S.

The display signal lines formed of the gate G₁ to Gₙ and the data lines D₁ to Dₘ have pads (not shown) formed by widening widths of the display signal lines at positions where the display signal lines are connected to the FPCs 650 and 680. The panel units 300M and 300S and the FPCs 650 and 680 are attached with anisotropic conductive layers (not shown) for electrical connection of the pads.

As shown in FIG. 3, each pixel PX, for example, a pixel PX connected to an i-th gate line Gᵢ (i=1, 2, . . . , n) and a j-th data line Dj (j=1, 2, . . . , m), includes a switching element Q connected to signal lines Gᵢ and Dⱼ, a liquid crystal capacitor C_{LC} connected to the switching element Q, and a storage capacitor CST. The storage capacitor CST may be omitted as needed.

The switching element Q is a three-terminal device, such as a thin film transistor, and is disposed in the lower panel 100 corresponding to the main panel unit 300M and has a control terminal connected to the gate line Gᵢ, an input terminal connected to the data line Dⱼ, and an output terminal connected to the liquid crystal capacitor C_{LC} and the storage capacitor C_{ST}.

Two terminals of the liquid crystal capacitor C_{LC} are a pixel electrode 191 of the lower panel 100 and a common electrode 270 of the upper panel 200 corresponding to the subsidiary panel unit 300S, and a liquid crystal layer interposed as shown at 3 between the two electrodes 191 and 270 serves as a dielectric member. The pixel electrode 191 is connected to the switching element Q, and the common electrode 270 is disposed in front of the upper panel 200 to receive a common voltage V_{com}. Unlike FIG. 2, the common electrode 270 may alternately be disposed to the lower panel 100, and in this case, at least one of the two electrodes 191 and 270 may be formed in a shape of a line or a bar.

The storage capacitor C_{ST} having an auxiliary function for the liquid crystal capacitor C_{LC} is constructed by overlapping a separate signal line (not shown) and the pixel electrode 191 provided to the lower panel 100 with an insulating member interposed therebetween, and a predetermined voltage such as the common voltage V_{com} is applied to the separate signal line. However, alternatively, the storage capacitor C_{ST} may be constructed by overlapping the pixel electrode 191 and a front gate line disposed just above with an insulating member interposed therebetween.

On the other hand, in order to implement color display, each of the pixels uniquely displays one of the primary colors (spatial division), or each of the pixels alternately displays the primary colors according to time (temporal division). A desired color can be obtained by a spatial or temporal combination of the primary colors. An example of the primary colors is three primary colors such as red, green, and blue. FIG. 2 shows an example of the spatial division. As shown in the figure, each of the pixels PX includes a color filter 230 for representing one of the primary colors, which is provided to a region of the upper panel 200 corresponding to the pixel electrode 191. Unlike FIG. 2, the color filter 230 may alternately be provided above or below the pixel electrode 191 of the lower panel 100.

At least one polarizer (not shown) for polarizing light is provided on outer surfaces of a liquid crystal display panel assembly 300 of FIG. 2.

A gray voltage generator 800 in FIG. 2 generates two grayscale voltage sets (reference grayscale sets) corresponding to transmittance of pixels PX. One grayscale set has a positive value with respect to the common voltage V_{com}, and the other grayscale voltage set has a negative value with respect to the common voltage V_{com}.

Each of the gate drivers 400M and 400S is connected to the gate lines G₁ to Gₙ to apply gate signals constructed with a combination of gate-on and gate-off voltages Vₒₙ and V_{off} which turn the switching transistors Q that are connected to the gate lines G₁ to Gₙ on and off. The gate drivers 400M and 400S together with the switching elements Q of the pixels PX are formed and integrated with the same process and are connected to the integration chip 700 through the signal lines SL1 and SL2 of FIG. 1.

A data driver 500 is connected to the data lines D₁ to Dₘ of the liquid crystal display panel assembly 300 to select the grayscales voltage from the gray voltage generator 800 and apply the grayscale voltages as data signals to the data lines D₁ to Dₘ. Alternatively, in a case where the grayscale voltage generator 800 generates only a predetermined number of reference grayscale voltages instead of all the grayscale voltages, the data driver 500 may generate the grayscale voltages for all the grayscales by dividing the reference grayscale voltages and selecting the data signals from among the generated grayscale voltages.

A signal controller 600 controls the gate driver 400, the data driver 500, and the like.

The integration chip 700 shown in FIG. 1 receives external signals through signal lines provided to an input FPC 660 and the main FPC 650, and applies processed signals to the main and subsidiary panel units 300M and 300S through wire lines provided to the peripheral regions 320M of the main panel unit 300M and the auxiliary FPC 680 to control the main and subsidiary panel units 300M and 300S. Referring to FIG. 2, the integration chip 700 includes the gray voltage generator 800, the data driver 500, and the signal controller 600.

Now, a display operation of the liquid crystal display device will be described in detail.

The signal controller 600 receives input image signals R, G, and B and input control signals for controlling display thereof from an external graphics controller (not shown). As an example of the input control signals, there are a vertical synchronization signal V_{sync}, a horizontal synchronization signal H_{sync}, a main clock signal MCLK, and a data enable signal DE.

The signal controller 600 processes the input image signals R, G, and B according to an operating condition of the liquid display panel assembly 300 based on the input control signals and the input image signals R, G, and B to generate a gate control signal CONT1, a data control signal CONT2, and the like, and then transmits the generated gate control signal CONT1 to the gate driver 400 and the generated data control signal CONT2 and the processed image signal DAT to the data driver 500.

The gate control signal CONT1 includes a scan start signal STV for indicating scan start, and at least one clock signal for controlling an output period of the gate-on voltage Vₒₙ. The gate control signal CONT1 may further include an output enable signal OE for defining a duration time of the gate-on voltage Vₒₙ.

The data control signal CONT2 includes a horizontal synchronization start signal STH for indicating data transmission for one pixel row, a load signal LOAD for commanding to apply the associated data voltages to the data lines D₁ to Dₘ, and a data clock signal HCLK. The data control signal CONT2 may further include a reverse signal RVS for inverting a voltage polarity of the data signal with respect to the common voltage V_{com} (hereinafter, “voltage polarity of the data signal with respect to the common voltage V_{com}” is abbreviated to “data signal polarity”).

In response to the data control signal CONT2 from the signal controller 600, the data driver 500 receives the digital image data DAT for one pixel row and selects the grayscale voltages corresponding to the digital image data DAT, so that the digital image data DAT are converted into the associated analog data signals. After that, the analog data signals are applied to the associated data lines D₁ to Dₘ.

The gate driver 400 applies the gate-on voltage Vₒₙ to the gate lines G₁ to Gₙ according to the gate control signals CONT1 from the signal controller 600 to turn on the switching elements Q connected to the gate lines G₁ to Gₙ. As a result, the data signals applied to the data lines D₁ to Dₘ are applied to the associated pixels PX through the turned-on switching elements Q.

A difference between the voltage of the data signal applied to the pixel PX and the common voltage V_{com} becomes a charge voltage of the liquid crystal capacitors C_{LC}, that is, a pixel voltage. Alignment of the liquid crystal molecules varies according to the intensity of the pixel voltage. Therefore, polarization of light passing through the liquid crystal layer 3 changes. The change in the polarization results in a change in transmittance of the light due to the polarizer attached to the liquid crystal display panel assembly 300.

In units of one horizontal period (or 1H), that is, one period of the horizontal synchronization signal H_{sync} and the data enable signal DE, the aforementioned operations are repetitively performed to sequentially apply the gate-on voltages Vₒₙ to all the gate lines G₁ to Gₙ, so that the data signals are applied to all the pixels. As a result, one frame of an image is displayed.

When one frame ends, the next frame starts, and a state of the reverse signal RVS applied to the data driver 500 is controlled, so that the polarity of the data signal applied to each of the pixels is opposite to the polarity in the previous frame (frame inversion). At this time, even in one frame, according to the characteristics of the reverse signals RVS, the polarity of the data signal flowing through the one data line may be inverted (row inversion and dot inversion). In addition, the polarities of the data signals applied to the one pixel row may be different from each other (column inversion and dot inversion).

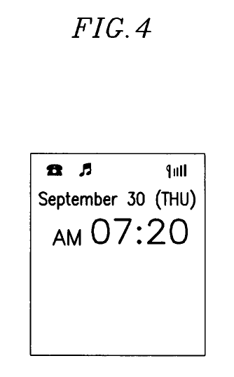

Now, a liquid crystal display device according to an embodiment of the present invention will be described in detail with reference to FIGS. 4 to 7.

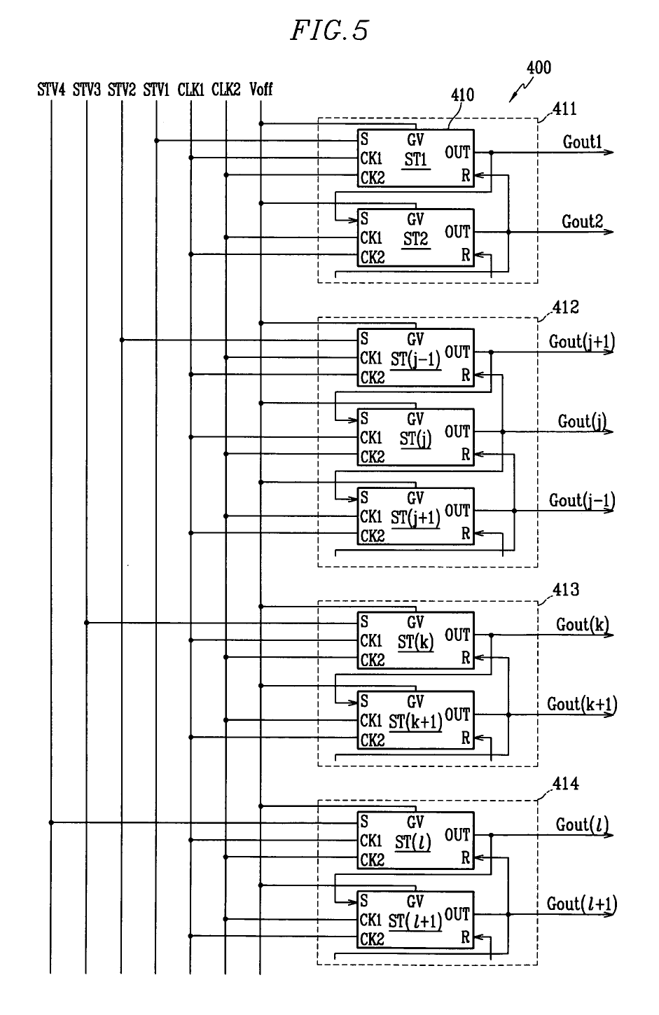

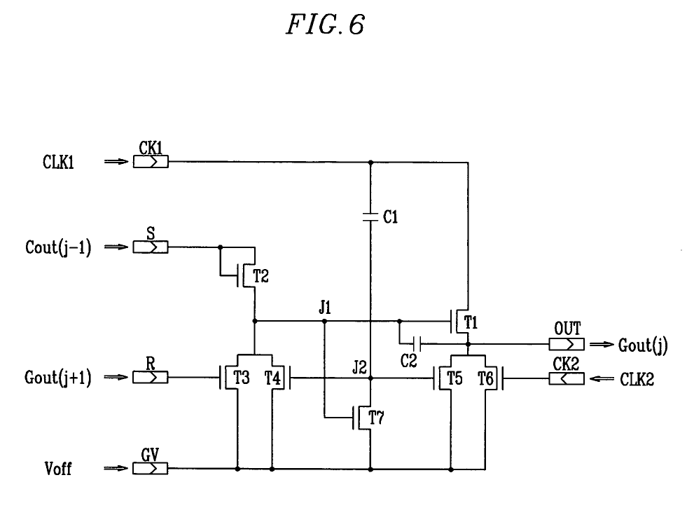

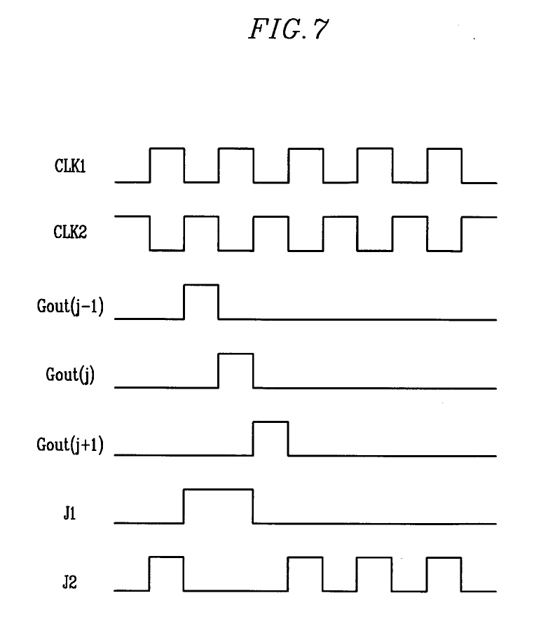

FIG. 4 is a view showing an example of partial driving of a liquid crystal display device according to an embodiment of the present invention, FIG. 5 is a block diagram showing a gate driver according to an embodiment of the present invention, and FIG. 6 is a circuit diagram showing an example of a j-th stage of a shift register for the gate driver shown in FIG. 5. FIG. 7 are waveforms of signals of the gate driver shown in FIG. 5.

Referring to FIG. 4, a date, a time, and the like are shown as an example of a screen to be displayed on the main panel or subsidiary panel 300M or 300S. The image is not displayed on the entire screen but only on a portion of the screen.

Now, a driving device for a display device that is capable of performing partial driving of the screen as well as complete driving of the screen will be described.

Referring to FIG. 5, the gate driver 400 is a shift register including a plurality of stages 410 arrayed in a row and connected to the gate lines G₁ to Gₙ. A plurality of scan start signals STV1 to STV4, a plurality of clock signals CLK1 and CLK2, and a gate-off voltage V_{off} are input to the gate driver 400. In addition, the shift register 400 includes four stage groups 411 to 414, each of which is connected to a predetermined number of the gate lines G₁ to Gₙ.

Each stage 410 has a set terminal S, a gate voltage terminal GV, a pair of clock terminals CK1 and CK2, a reset terminal R, and a gate output terminal OUT.

In each stage, for example, a j-th stage ST(j), the set terminal S is applied with a gate output of a last stage ST(j−1), that is, a last-stage gate output Gout(j−1), and the reset terminal R is applied with a gate output of a next stage ST(j+1), that is, a next-stage gate output Gout(j+1). In addition, the clock terminals CK1 and CK2 are applied with the clock signals CLK1 and CLK2, and the gate voltage terminal GV is applied with the gate-off voltage V_{off}. The gate output terminal OUT transmits a gate output Gout(j).

However, first stages of the stage groups 411 to 414 are applied with the scan start signals STV1 to STV4 instead of the last-stage gate outputs, respectively. When the clock terminals CK1 and CK2 of the j-th state ST(j) are applied with the clock signals CLK1 and CLK2, respectively, the clock terminals CK1 and CK2 of the (j−1)-th and (j+1)-th stages ST(j−1) and ST (j+1) adjacent to the j-th stage ST(j) are applied with the clock signals CLK2 and CLK1, respectively.

When the voltage level is high enough to drive the switching element Q, the clock signals CLK1 and CLK2 are preferably the same as the gate-on voltage Vₒₙ. When the voltage level is low, the clock signals CLK1 and CLK2 are preferably the same as the gate-off voltage V_{off}. As shown in FIG. 7, the clock signals CLK1 and CLK2 may have a duty ratio of 50% and a phase difference of 180°.

Referring to FIG. 6, each stage, for example the j-th stage, of the gate driver 400 according to the embodiment of the present invention includes a plurality of NMOS transistors T1 to T7 and capacitors C1 and C2. Alternatively, instead of the NMOS transistors, PMOS transistors may be used. In addition, the capacitors C1 and C2 may be parasitic capacitances formed between drain and source electrodes during production processes.

The transistor T1 is connected between the clock terminal CK1 and output terminal OUT, and a control terminal of the transistor T1 is connected to a contact point J1.

The input terminal and control terminal of the transistor T2 are commonly connected to the set terminal S, and the output terminal of the transistor T2 is connected to the contact point J1.

The transistors T3 and T4 are connected in parallel to each other between the contact point J1 and the gate voltage terminal GV. The control terminal of the transistor T3 is connected to the reset terminal R, and the control terminal of the transistor T4 is connected to a contact point J2.

The transistors T5 and T6 are connected between the output terminal OUT and the gate voltage terminal GV. The control terminal of the transistor T5 is connected to the contact point J2, and the control terminal of the transistor T6 is connected to the clock terminal CK2.

The transistor T7 is connected between the contact point J2 and the gate voltage terminal GV, and the control terminal of the transistor T7 is connected to the contact point J1.

The capacitor C1 is connected between the clock terminal CK1 and the contact point J2, and the capacitor C2 is connected between the contact point J1 and the output terminal OUT.

Now, operations of the stages, for example the j-th stage STj, will be described.

For convenience of description, a voltage corresponding to the high level of the clock signals CLK1 and CLK2 is referred to as a high voltage, and a voltage corresponding to the low level of clock signals CLK1 and CLK2 is referred to as a low voltage, which is equal to the gate-off voltage V_{off}.

First, when the clock signal CLK2 and the last-stage gate output Gout(j−1) are in the high level, the transistors T2, T6, and T7 turn on. Accordingly, the transistor T2 transmits the high voltage to the contact point J1, the transistor T6 transmits the low voltage to the output terminal OUT, and the transistor T7 transmits the low voltage to the contact point J2. As a result, the transistor T1 turns on, and the clock signal CLK1 is output to the output terminal OUT. At this time, since the clock signal CLK1 has the low voltage, the output voltage Gout(j) has the low voltage. At the same time, since the capacitor C1 has the same voltages at both ends thereof, the capacitor C1 is not charged, but the capacitor C2 is charged with a voltage corresponding to a difference between the high voltage and the low voltage.

At this time, the clock signal CLK1 and the next-stage gate output Gout(j+1) are in the low level, and the contact point J2 is also in the low level, so that all the transistors T3, T4, and T5 of which the control terminals are connected to the clock signal CLK1 or the next-stage gate output Gout(j+1) are in the off state.

Subsequently, when the clock signal CLK2 and the last-stage gate output Gout(j−1) are in the low level, the transistors T6 and T2 turn off. Accordingly, the capacitor C2 is in the floating state, so that the transistor T1 is maintained in the turned-off state.

At this time, since the clock signal CLK1 is in the low level, the voltage of the output terminal OUT is changed into the high level, and the potential of the contact point J1 increases by the high voltage due to the capacitor C2. Although the potential of the contact point J1 is shown to be the same as the previous voltage, the potential of the contact point J1 actually increases by the high voltage.

At this time, since the next-stage gate output Gout(j+1) and the contact point J2 are in the low level, the transistors T5 and T6 are also in the turned-off state. Accordingly, the output terminal OUT is connected to only the clock signal CLK1 and is disconnected from the low voltage, so that the high voltage is output from the output terminal OUT.

The capacitor C1 is charged with a voltage corresponding to a potential difference between the two terminals thereof.

Next, the next-stage gate output Gout(j+1) and the clock signal CLK2 are in the high level, and the clock signal CLK1 is in the low level, so that the transistor T3 turns on to transmit the low voltage to the contact point J1. Accordingly, the transistor T7 of which the control terminal is connected to the contact point J1 turns off. Therefore, the capacitor C1 is in the floating state, and the contact point J2 is maintained in the previous voltage level, that is, the low voltage level. At this time, since the clock signal CLK1 is in the low level, a voltage between the two terminals of the capacitor C1 is 0V.

At the same time, since the transistor T1 turns off, the output terminal OUT is disconnected from the clock signal CLK1. On the contrary, when the transistor T6 turns on, the output terminal OUT is connected to the low voltage, so that the low voltage is output from the output terminal OUT.

Next, when the clock signal CLK1 is in the high level, the voltage of one terminal of the capacitor C1 is changed into the high voltage, and the voltage of the other terminal of the capacitor C1, that is, the voltage of the contact point J2, is changed into the high voltage, so that the voltage between the two terminals of the capacitor C1 is maintained at the voltage of 0V. Accordingly, the transistor T4 turns on to transmit the low voltage to the contact point J1, so that the transistor T1 is maintained in the turned-on state. The transistor T5 turns on the low voltage to the output terminal OUT, so that the output terminal OUT continuously outputs the low voltage.

After that, until the last-stage gate output Gout(j−1) is in the high level, the voltage of the contact point J1 is maintained at the low voltage, and the voltage of the contact point J2 is changed in synchronization with the clock signal CLK1 due to the capacitor C1. Therefore, when the clock signals CLK1 and CLK2 have the high and low levels, respectively, the output terminal OUT is connected to the lower voltage through the transistor T5. On the contrary, when the clock signals CLK1 and CLK2 have the low and high levels, respectively, the output terminal OUT is connected to the lower voltage through the transistor T6.

In this manner, the stage 411 generates the gate output Gout(j) based on the last-stage and next-,stage gate outputs Gout(j−1) and Gout(j+1) in synchronization with the clock signals CLK1 and CLK2. As described above, the shift register 400 for a display device according to the embodiment of the present invention includes a plurality of the stage groups 411 to 414, and each of the stage groups 411 to 414 is connected to a predetermined number of the gate lines G₁ to Gₙ. The first stages ST1, ST(j−1), ST(k), and ST(l) of the stage groups 411 to 414 are applied with the first to the fourth scan start signals STV1 to STV4, respectively, instead of the gate outputs of the last stages thereof. Namely, first stages of the stage groups 411 to 414, particularly, the first stages ST(j−1), ST(k), and ST(l) of the stage groups 412 to 414, are not connected to the last stages (not shown) of the upper adjacent stage groups 411 to 413. For example, when the third scan start signal STV3 is input, only the stage group 413 operates and displays a partial image on the screen, and when the fourth scan start signal STV4 is input, only the stage group 414 operates and displays a partial image on the screen.

In addition, the first and third scan start signals STV1 and STV3 may be simultaneously input. Further, the second and fourth scan start signals STV2 and STV4 may be simultaneously input.

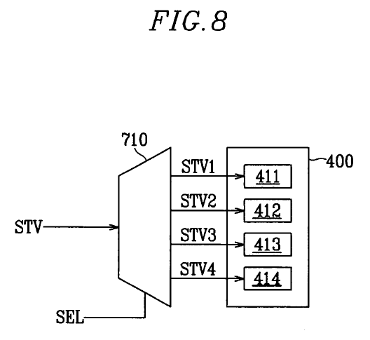

Such selection of the scan start signals STV1 to STV4 may be performed by using a de-multiplexer 710 as shown in FIG. 8. The de-multiplexer 710 may be embedded in the integration chip 700 shown in FIG. 1. As described, by selecting one or two of the first to fourth scan start signals STV1 to STV4, an image on a part of the screen can be displayed. Otherwise, by sequentially selecting all the first to fourth scan start signals STV1 to STV4, the entire screen can be displayed.

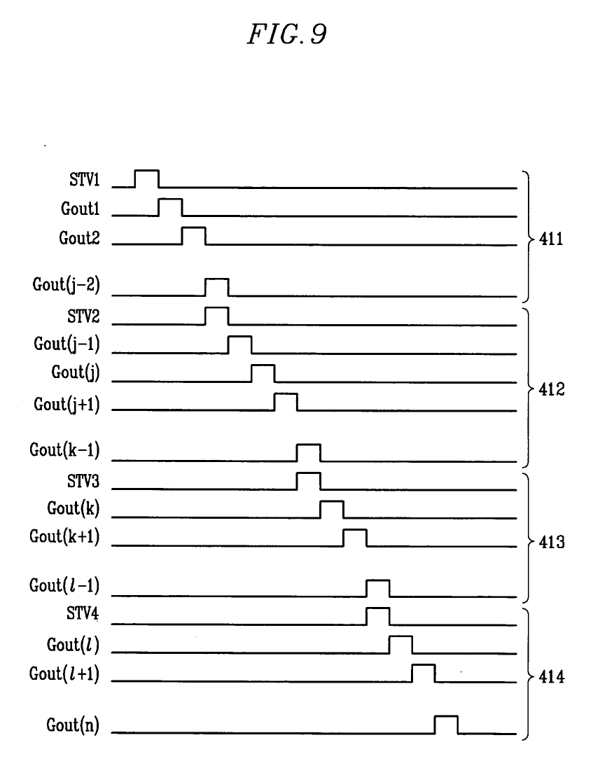

For example, as shown in FIG. 9, the gate output of the last stage of the first stage group 411 is denoted by Gout(j−2), the gate output of the last stage of the second stage group 412 is denoted by Gout(k−1), and the gate output of the last stage of the third stage group 413 is denoted by Gout(l−1). When the gate output Gout(j−2), Gout(k−1), and Gout(l−1) of the last stages of the stage groups 411 to 413 are generated, the second to fourth scan start signals STV2 to STV4 may be input. Accordingly, as described above, the gate outputs are sequentially output, so that the entire screen can be displayed. In other words, the second to fourth scan start signals STV2 to STV4 are input in synchronization with the gate output Gout(j−2), Gout(k−1), and Gout(l−1) of the last stages of the stage groups 411 to 413. On the other hand, instead of the aforementioned last and next gate outputs Gout(j−1) and Gout(j+1), separate carry signals may be applied to the set and reset terminals S and R. In addition, although the shift register according to the embodiment of the present invention is divided into four stage groups 411 to 414, the present invention is not limited thereto, but at least two stage groups are sufficient.

In such a manner, only the necessary portion of the screen can be displayed, so that it is possible to reduce power consumption. For an outer display panel of a dual display device or a medium or small sized liquid crystal display device such as a slide-type phone, a transflective panel that is capable of operating in reflecting and transmitting modes is generally used. Particularly, in the reflecting mode, since time or data may be displayed on the screen all the time as shown in FIG. 4, it is possible to further reduce power consumption by using the partial driving.

According to the present invention, a shift register is divided into a plurality of stage groups, and only the necessary portion of a screen can be displayed, so that it is possible to further reduce power consumption. Although the exemplary embodiments and the modified examples of the present invention have been described, the present invention is not limited to the embodiments and examples, but may be modified in various forms without departing from the scope of the appended claims, the detailed description, and the accompanying drawings of the present invention. Therefore, it is natural that such modifications belong to the scope of the present invention.

What is claimed is:

1. A shift register for a display device having at least two display regions, each display region including pixels and signal lines connected thereto, the shift register comprising
at least two stage groups, each stage group including a plurality of stages connected to each other to sequentially generate output signals,
wherein each stage group transmits the output signals to the signal lines included in one of the two display regions.

2. The shift register of claim 1, wherein at least one of the stage groups is applied with a scan start signal.

3. The shift register of claim 2, wherein the scan start signal is inputted to a first stage of each stage group.

4. The shift register of claim 3, wherein the scan start signal is inputted in synchronization with an output of a last stage of preceding adjacent stage group.

5. The shift register of claim 1, wherein each stage includes set, reset, gate-off voltage, and output terminals, and first and second clock terminals.

6. The shift register of claim 5, wherein each stage comprises:
a first switching element having a first terminal connected to the first clock terminal, a second terminal connected to a first contact point, and a third terminal connected to the output terminal;
a second switching element having first and second terminals commonly connected to the set terminal and a third terminal connected to the first contact point;
a third switching element having a first terminal connected to the first contact point, a second terminal connected to the reset terminal, and a third terminal connected to the gate voltage terminal;
a fourth switching element having a first terminal connected to the first contact point, a second terminal connected to a second contact point, and a third terminal connected to the gate-off voltage terminal;
a fifth switching element having a first terminal connected to the output terminal, a second terminal connected to the second contact point, and a third terminal connected to the gate-off voltage terminal;
a sixth switching element having a first terminal connected to the output terminal, a second terminal connected to the second clock terminal, and a third terminal connected to the gate-off voltage terminal;
a seventh switching element having a first terminal connected to the second contact point, a second terminal connected to the first contact point, and a third terminal connected to the gate-off voltage terminal;
a first capacitor connected between the first clock terminal and the second contact point; and
a second capacitor connected between the first contact point and the output terminal.

7. The shift register of claim 6, wherein the first to seventh switching elements are made of amorphous silicon.

8. A display device comprising:
at least two display regions, each display region including a plurality of pixels including switching elements and a plurality of signal lines connected to the switching elements; and
a shift register having plurality of stage groups, each including a plurality of stages connected to each other to sequentially generate output signals and apply the output signals to signal lines included in one of the two display regions.

9. The display device of claim 8, wherein at least one of the stage groups is applied with a scan start signal.

10. The display device of claim 9, wherein the scan start signal is input to a first stage of each stage group.

11. The display device of claim 10, wherein the scan start signal is inputted in synchronization with an output of a last stage of a preceding adjacent stage group.

12. The display device of claim 8, wherein each stage includes set, reset, gate off voltage, and output terminals, and first and second clock terminals.

13. The display device of claim 12, wherein each stage comprises:
a first transistor having a first terminal connected to the first clock terminal, a second terminal connected to a first contact point, and a third terminal connected to the output terminal;
a second transistor having first and second terminals commonly connected to the set terminal and a third terminal connected to the first contact point;
a third transistor having a first terminal connected to the first contact point, a second terminal connected to the reset terminal, and a third terminal connected to the gate-off voltage terminal;
a fourth transistor having a first terminal connected to the first contact point, a second terminal connected to a second contact point, and a third terminal connected to the gate-off voltage terminal;
a fifth transistor having a first terminal connected to the output terminal, a second terminal connected to the second contact point, and a third terminal connected to the gate-off voltage terminal;
a sixth transistor having a first terminal connected to the output terminal, a second terminal connected to the second clock terminal, and a third terminal connected to the gate-off voltage terminal;
a seventh transistor having a first terminal connected to the second contact point, a second terminal connected to the first contact point, and a third terminal connected to the gate-off voltage terminal;
a first capacitor connected between the first clock terminal and the second contact point; and
a second capacitor connected between the first contact point and the output terminal.

14. The display device of claim 13, wherein the first to seventh transistors are made of amorphous silicon.

15. The display device of claim 9, further comprising a circuit unit for outputting a plurality of the scan start signals at different times.

16. The display device of claim 15, wherein some of the scan start signals are inputted in synchronization with an output of a last stage of the plurality of stage groups.

17. The display device of claim 8, further comprising a panel unit having the display region,
wherein the shift register is integrated in the panel unit.

18. The display device of claim 8, wherein the display regions are liquid crystal display devices.

19. The display device of claim 18, wherein the liquid crystal display devices are of a transflective type.
